(19) United States
(12) Patent Application Publication
(10) Pub. No.: US 2009/0005014 A1
(43) Pub. Date: Jan. 1, 2009

(54) CALL BACK SYSTEM AND METHOD FOR DIRECTING CUSTOMER SERVICE REPRESENTATIVE TO A MOBILE DEVICE ASSOCIATED WITH A CUSTOMER

(76) Inventor: Michael David VERNICK, Ocean, NJ (US)

Correspondence Address: MG-IP Law, PLLC, PO BOX 1364, FAIRFAX, VA, 22038-1364, US

(21) Appl. No.: 11/770,336

(22) Filed: Jun. 28, 2007

(51) Int. Cl. H04M 3/42

(52) U.S. Cl. 455/414.1

(57) ABSTRACT

One or more method(s), system(s), call-back device(s), and/or computer readable medium(s) establishes a customer service transaction between a user and a customer service representative. The user is provided access to a customer service terminal having a user interface configured to permit the user to enter a customer ID associated with a mobile device of the user. The customer ID, and optionally location information as well, is received at the customer service terminal and is transmitted to a customer service representative through a network operably coupled to the customer service terminal. A customer service transaction is initiated at the customer service terminal and is handed-off to the mobile device of the user, e.g., a cellular phone of the user is automatically dialed by the server. The user is able to move freely throughout a retail establishment or other location while communicating with the customer service representative.

### BACKGROUND

This description generally relates to customer service terminals, and more particularly to one or more methods, systems, and/or call back devices for directing customer service representatives to a mobile device associated with a customer, such as in a retail service environment.

### DESCRIPTION OF THE BACKGROUND ART

Self-service kiosks are typically provided in retail service establishments or other public environments to facilitate the exchange of information between retail customers and the owner of a retail service business. Kiosks may be used to provide users with information relating to product or service availability. For example, kiosks may be used by customers to obtain information relating to products available for in-store purchase in a retail setting, available seating or flight information in an airport, and/or other users seeking location information, such as directions to businesses or contact information, e.g., hotels or other businesses within a targeted geographic area.

Self-service kiosks often provide users with ways of contacting a service representative, such as through a customer service call initiated at a self-service kiosk or through content directed to the self-service kiosk, or in a web-based setting where the user can navigate through web-based content relating to the desired customer service inquiry, e.g., product availability, store location, pricing, etc. However, the aforementioned examples of self-service kiosks typically require that the user remain at the kiosk and/or even log-in a secure session to transact a customer service inquiry and/or otherwise communicate with an available customer-service representative while forced to remain in proximity to the kiosk.

### SUMMARY

One or more of the following aspects may provide one or more of the following advantages. For example, customer service requests and transactions can be more efficiently handled by a customer service center if the supporting customer service system provides the user, e.g., customer, direct access to customer service representative(s) while still permitting the user the ability to move freely throughout a retail setting and/or even off-site. A customer is provided with the ability to immediately contact available customer service representatives without having to wait in a single location within a store. In addition, the customer and/or customer service representative may also exchange location-specific information and/or services after establishing a customer-service call with a customer service representative, e.g., via the customer's own mobile phone. The customer does not need to know the number or other contact information of the customer service representative, but instead may simply enter their own customer ID, e.g., mobile phone number, to prompt a customer service representative to contact the customer through the customer's own mobile device.

In one general aspect, a method for establishing a customer service transaction between a user and a customer service representative includes providing the user access to a customer service terminal having a user interface configured to permit the user to enter a customer ID associated with a mobile device of the user. The customer ID is received at the customer service terminal and transmitted to a customer service representative through a network operably coupled to the customer service terminal. The customer service transaction is initiated between the user and the customer service representative, and through the mobile device of the user.

Implementations of this aspect may include one or more of the following features. For example, the customer service terminal may be a portable device operably coupled through a wireless network to a customer service server. The customer service terminal may be a device operably coupled through a wired connection to a customer service server on the network. The user interface may include a keypad and a display. The display may be configured to display status of a customer service transaction and the customer ID received at the customer service terminal. The user interface may include only a keypad and a display, the display being configured to display status of a customer service transaction and the customer ID received at the customer service terminal. The keypad may include an alphanumeric keypad and a call request button. The keypad may consist of only an alphanumeric keypad and a call request button. The customer ID may include a mobile telephone number associated with the user.

A user profile can be retrieved based on the customer ID transmitted to the customer service representative. User-specific information can be provided to the user during the customer service transaction. The customer service transaction can include at least one of a text message, an instant message, an electronic mail message, or a voice-based telephony call delivered to the user through the mobile device. Location information associated with the customer service terminal can be transmitted to the customer service representative. The user may be updated with a hand-off status of the customer service transaction on the customer service terminal. Updating the user with the hand-off status may include displaying an indication of a customer service transaction on a display of the customer service terminal. The indication can include information indicating the customer service transaction being established with the user's mobile device or not being established with the user's mobile device. The mobile device can include a cellular telephone, a personal digital assistant (PDA), or a RF-based telecommunications device. Transmitting the customer ID can consist of transmitting only the customer ID and location information associated with the customer service terminal to the customer service representative.

In another general aspect, a system for establishing a customer service transaction between a user and a customer service representative includes a customer service terminal and a customer service center. The customer service terminal includes a user interface configured to permit the user to enter a customer ID associated with a mobile device of the user, and a transmission device configured to transmit the customer ID to a customer service representative through a network operably coupled to the customer service terminal. The customer service center includes a server, operably connected to the customer service terminal through the network. The customer service center is configured to automatically initiate a customer service transaction between the user and the customer service representative based on receipt of the customer ID from the customer service terminal and through a mobile device of the user.

Implementations of this aspect may include one or more of the following features. For example, the customer service terminal can be a portable device operably coupled through a wireless network to the customer service server. The customer service terminal can be a device operably coupled through a wired connection to the customer service server on the network. The user interface can include a keypad and a display, the display being configured to display status of a customer service transaction and the customer ID received at the customer service terminal. The user interface may include only a keypad and a display, the display being configured to display status of a customer service transaction and the customer ID received at the customer service terminal. The keypad may include an alphanumeric keypad and a call request button. The keypad may include only an alphanumeric keypad and a call request button. The customer ID can be a mobile telephone number.

The server of the customer service center can include a database including one or more user profiles associated with one or more customer IDs. The customer service center can be configured to transmit a message to the mobile device of the user, the message including at least one of a text message, an instant message, an electronic mail message, or a voice-based telephony call delivered to the user through the mobile device. The server at the customer service center can be configured to determine location information associated with the customer service terminal, e.g., based on a comparison to a lookup table relating location information to one or more customer terminals or through location information or location identifiers sent with or as part of the customer ID.

The user interface can be configured to update the user with a hand-off status of the customer service transaction on the display of the customer service terminal. The user interface can be configured to update the user with a hand-off status of the customer service transaction on the display of the customer service terminal. The user interface can be configured to provide an indication, through the customer service terminal, of the customer service transaction being established with the user's mobile device or not being established with the user's mobile device. The mobile device can include a cellular telephone, a personal digital assistant (PDA), or a RF-based telecommunications device. The customer service terminal can be configured to transmit the customer ID and location information associated with the customer service terminal to the customer service representative. The customer service terminal can configured to transmit only the customer ID and location information associated with the customer service terminal to the customer service representative.

In another general aspect, a computer-readable medium having computer-executable instructions contained therein for a method for establishing a customer service transaction between a user and a customer service representative can be stored on and/or executed on various customer service terminals and/or at the customer service terminal. The aforementioned method for establishing the customer service transaction between the user and the customer service representative includes receiving a customer ID associated with a mobile device of the user at a user interface of a customer service terminal. The customer ID is transmitted to a customer service representative through a network operably coupled to the customer service terminal, and a customer service transaction is initiated between the user and the customer service representative, and through the mobile device of the user, e.g., automatically initiated between the user's mobile device and the customer service representative through one or more communication protocols, e.g., text messaging, instant messaging, phone calls through IP telephony, cellular phone, or analog phone lines, electronic messages, and/or web-based content.

In another general aspect, a customer service call-back device includes a network interface configured to operably connect to a server of a customer service center, a user interface, and a transmission device. The user interface is configured to permit the user to enter a customer ID associated with a mobile device of the user. The user interface includes a keypad and a display. The keypad includes a call request button configured to initiate a transmission of the customer ID to the server of the customer service center. The display is configured to display status of a customer service transaction and the customer ID entered through the keypad of the user interface. The transmission device is configured to transmit the customer ID to a customer service representative through the network interface and to the customer service center.

Implementations of this aspect may include one or more of the following features. For example, the user interface may consist of only the keypad and the display, and the call back device may be configured to transmit only location information and the customer ID to the customer service center, e.g., the customer ID may include location information when transmitted to the customer service center.

### BRIEF DESCRIPTION OF THE DRAWINGS

Further aspects and advantages will become apparent upon reading the following detailed description taken in conjunction with the accompanying drawings summarized below.

FIG. 1 is a schematic view of an exemplary telecommunications network which includes a customer service terminal and server.

FIG. 2 is a block diagram of an exemplary customer service terminal.

FIG. 3 is a plan view of an exemplary customer service terminal having a user interface.

FIG. 4 is a schematic view of a customer service network which includes a customer service terminal and a server for establishing a customer service transaction between a customer service representative and a customer through the customer's mobile device.

FIG. 5 is a flowchart of an exemplary process for establishing a customer service transaction through a customer service terminal and a customer's mobile device.

### DETAILED DESCRIPTION

One or more embodiments are more specifically set forth in the following description with reference to the appended figures. Wherever possible, the same reference numbers will be used throughout the drawings to refer to the same or like parts.

Further, many embodiments are described in terms of sequences of actions to be performed by, for example, elements of a computing device. It will be recognized that various actions described herein can be performed by specific circuits (e.g., application specific integrated circuits (ASICs)), by program instructions being executed by one or more processors, or by a combination of both. Additionally, these sequence of actions described herein can be considered to be embodied entirely within any form of computer readable storage medium having stored therein a corresponding set of computer instructions that upon execution would cause an associated processor to perform the functionality described herein. Thus, one or more aspects may be embodied in a number of different forms, all of which have been contemplated to be within the scope of the claimed subject matter. In addition, for each of the embodiments described herein, the corresponding form of any such embodiments may be described herein as, for example, “logic configured to” perform the described action.

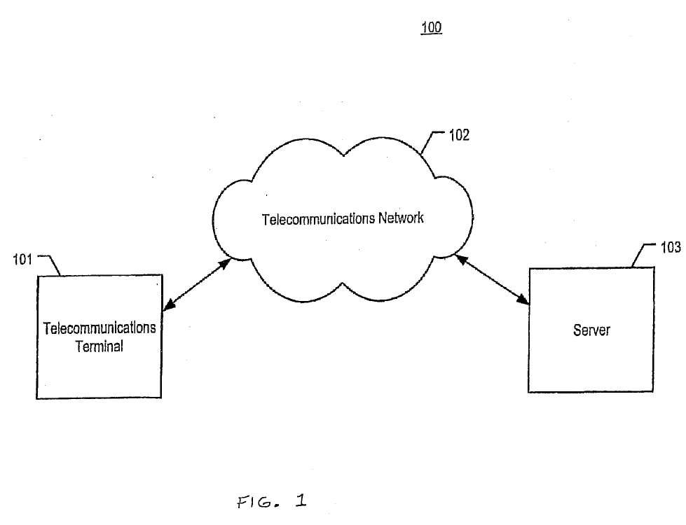

As described above, there is a need for intuitive, simple, and easy to use telecommunications terminals, e.g., call back boxes, for use by visitors, customers, building employees, etc. in common areas or shared spaces of a customer's location, such as retail establishment, hotel lobbies, hospital entrances, corporate conference rooms, reception areas, waiting areas, printer or copier rooms, breakrooms, hallways, etc. The exemplary embodiments of a telecommunications terminal described below can provide telephone services and/or informational content to users in a simple and easy to use manner. The exemplary embodiments can be configured to be simple and intuitive in order to keep the experience simple and easy for walk-up users. Thus, the exemplary embodiments can provide a smart telephony and information endpoint located in the shared space of a customer's location. Exemplary embodiments of a telecommunications terminal will be described below with reference to FIGS. 1 through 5.

FIG. 1 depicts an exemplary telecommunications system 100, in accordance with an illustrative embodiment. The telecommunications system 100 can include, for example, a telecommunications terminal 101, a telecommunications network 102, and a server 103, which can be interconnected as exemplarily shown.

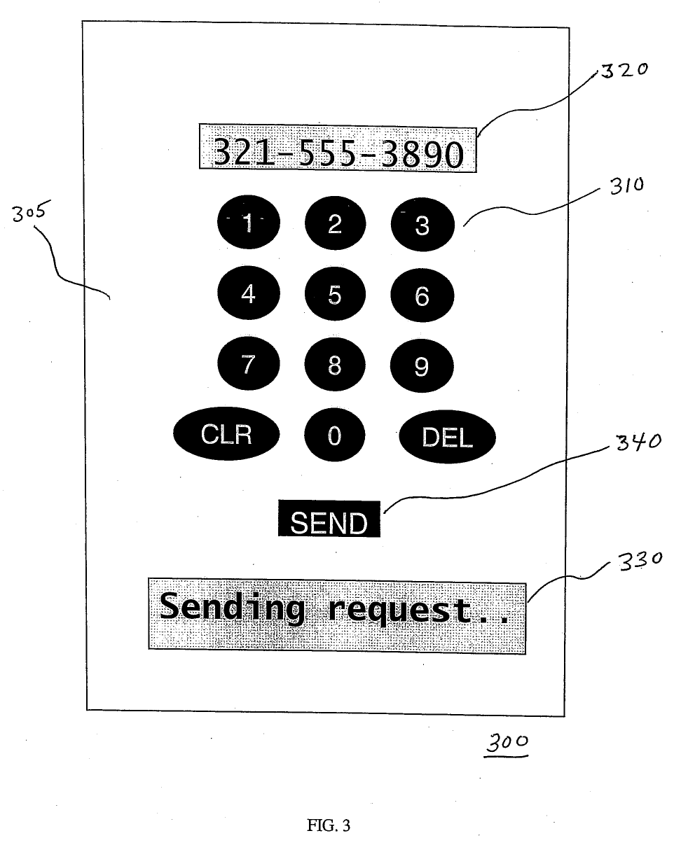

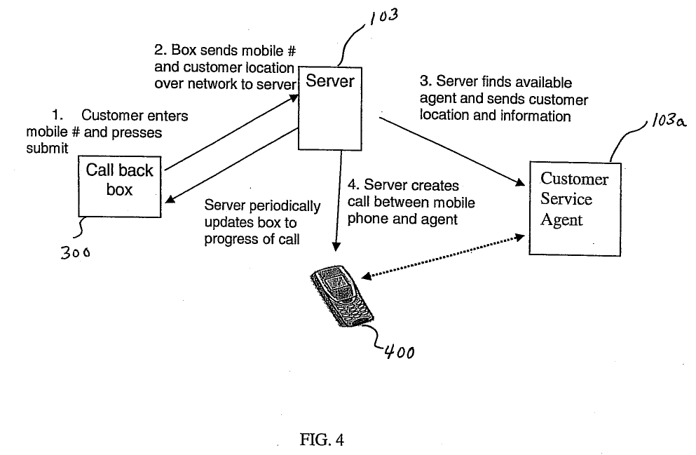

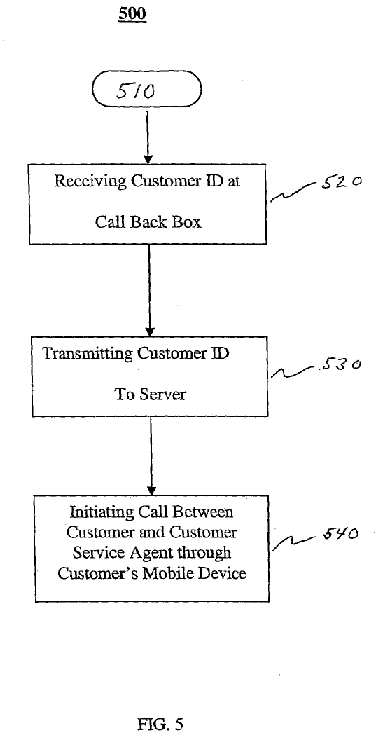

The telecommunications terminal 101 can be a client machine that is capable of transmitting and receiving packets of data via the telecommunications network 102, in a well-known fashion. For example, a user of the terminal 101 can submit information, whereupon the terminal 101 can transmit the information to a content server, such as a server 103, and can subsequently receive the requested information. The terminal 101 also can be capable of performing one or more of the tasks described below and with respect to FIGS. 4 and 5, in accordance with other exemplary embodiments. However, in a preferred embodiment, the terminal 101 is a customer service terminal, e.g., call back box 300 (FIGS. 3 and 4) with relatively simple transmission and receiving capabilities of data via the telecommunications network 102. The terminal 101 can be an Internet Protocol (IP) telephone connected through a wired or wireless connection to the network 102. In other exemplary embodiments, the terminal 101 can be other types of a telecommunications terminal, such as a Personal Digital Assistant (PDA), softphone, Session Initiation Protocol (SIP) endpoint, H.323 endpoint, personal computer, or wired, analog telephone, etc.

The telecommunications network 102 can provide for end-to-end data communications between one or more clients, such as one or more terminal(s) 101, and one or more servers, such as server 103. The network 102 can comprise the Internet, a LAN, or WAN in accordance with the exemplary embodiments. In other exemplary embodiments, the network 102 can comprise a different network or networks (e.g., an Ethernet-based network, etc.), in addition to or as an alternative to the Internet. The server 103 can be, for example, a source of stored data content, such as web pages and other information that is presentable to a user and/or a customer service agent connected on an enterprise side of a server 103. Moreover, the server 103 can be capable of transmitting and receiving packets of data that are related to the stored content, via the telecommunications network 102 in a well-known fashion. The server 103 can transmit the content in the form of one or more computer files to a client, such as the terminal 101, for example, either (i) when the client requests the content or (ii) autonomously.

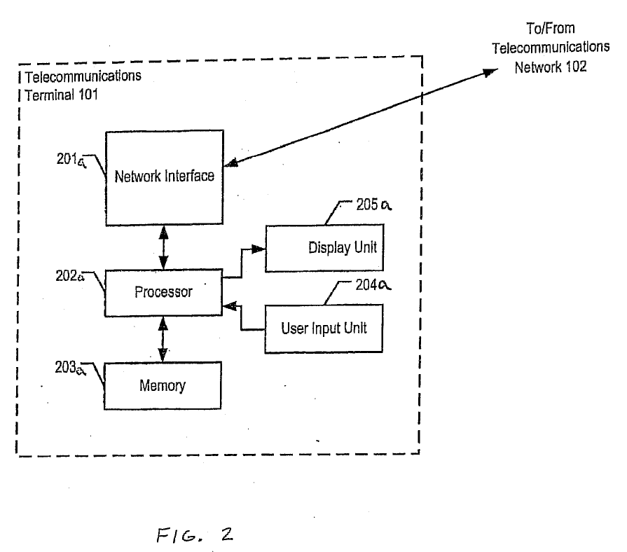

FIG. 2 depicts a block diagram of the salient components of a telecommunications terminal 101, in accordance with an exemplary embodiment. The telecommunications terminal 101 can include, for example, a network interface 201a, a processor 202a, a memory 203a, a user input unit 204a, and a display unit 205a, interconnected as shown. The network interface 201a can include a receiving part and a transmitting part, e.g. for receiving and transmitting data between the server 103 and the terminal 101. The receiving part can receive signals from the network 102, and forward the information encoded in the signals to the processor 202a, for example, in a well-known fashion. The transmitting part can receive information from the processor 202a, and output signals that encode this information to the network 102, in a well-known fashion.

The processor 202a can be, for example, a general-purpose processor that is capable of (i) receiving information from the network interface 201a and the user input unit 204a, (ii) reading data from and writing data into the memory 203a, (iii) executing the tasks described below and with respect to FIGS. 4 through 5, and (iv) transmitting information to the network interface 201a and the display unit 205a. In other exemplary embodiments, the processor 202a can be a special-purpose processor. In either case) it will be clear to those skilled in the art that processor may be configured in various ways for implementing various features of the client terminal 101.

The memory 203a can be various types of memory, including, for example, a non-volatile random-access memory that stores the instructions and the data used by the processor 202a. In accordance an exemplary embodiment, the memory 203a also can store additional information, e.g., browser applications and/or retrieve computer files that contain the data content.

The user input unit 204a is a character and user-selection input device that can receive input from a user and transmit signals that represents the input to the processor 202a. The user input unit 204a can comprise fixed function keys (e.g., hard keys) and/or soft keys, and can provide a user input interface, for example, as shown in the exemplary embodiments described hereinafter in greater detail in connection with FIGS. 3 through 5. The user input unit 204a can include an array of buttons, for example, as shown and described in greater detail hereinafter with respect to FIGS. 3 through 5. The display unit 205a can be a display output system that can receive a signal and create a visual image of the signal for a user. The display unit 205a can include a display, for example, as shown in the exemplary embodiments described below.

Referring to FIG. 3, an exemplary customer service terminal 101 is configured as a call-back box 300. The call-back box 300 may include various degrees of functionality depending upon the customer service needs of a particular service location. However, the call-back box 300 in FIG. 3 is configured to include relatively simple functionality to enable a customer seeking customer service support to reach a customer service representative with minimal effort. For example, call-back box 300 includes a user interface 305 on a front surface of the box 300 which includes a display 320, 330, and a keypad 310, 340. The display 320, 3330 includes a customer ID display screen 320 and a status display screen 330. The keypad 310, 340 includes one or more buttons and/or softkeys, such as an alphanumeric keypad 310. The alphanumeric keypad 310 may include number keys for entering a customer's mobile phone number or other customer ID into the box 300. Alternatively, the number keys may be alphanumeric keys, such as an ISO-standard alphanumeric telephony keypad providing the entry of combinations of numbers, text, and/or both.

In addition, a clear function and a delete function are provided to permit the customer the ability to edit inputs and/or cancel active customer service requests, e.g., the delete function may be used to edit an unsubmitted phone number entered by the customer or to cancel a customer service call that has been requested, but still not connected or handed-off to the customer's mobile phone. The customer ID display screen 320 provides visual feedback to a customer of any information inputted by the customer to the box 300. The status display screen 330 provides visual feedback of the status of a customer service request, e.g., one or more status updates can be provided, such as sending request, request cancelled, connected with customer service, etc. In addition, the keypad is provided with a send button 340, e.g., a send request button preconfigured to automatically send data input to a user to a customer service server 103. The status display screen 330 and customer ID display screen 320 may be further consolidated into a single display, e.g., a multiple line display which shows entered customer ID information and status updates on the same screen simultaneously or sequentially.

In this manner, the customer may input a predefined customer ID number, e.g., an account number associated with a user's preferred mobile phone number or the phone number of the customer's preferred mobile telecommunications device, to contact a customer service representative without having to enter or know a customer service phone number. Rather than having to wait at the call-back box 300, the customer may travel away from the call-back box 300 if secured in a fixed location. Alternatively, the call-back box may be a portable device, e.g., that a customer may carry while in the store or other location, such as fixed to a shopping cart(s) in a grocery store or hardware and building supply store.

Referring to FIG. 4, the call-back box 300 permits the user to enter a customer ID, such as an account number or a preferred mobile phone number through the user interface 305. The call-back box 300 transmits the customer ID to the customer service server 103. The customer ID being transmitted may include location information, e.g., location code information associated with a particular retail establishment or an ID code for the call-back box 300 that may be linked to more specific location information stored in a database (not shown) of the server 103, such as in a look-up table. The location information may be sent as a separate data packet or attached to the customer ID input by the customer in a single, parseable data packet that may be received and analyzed at the server 103. Upon receipt of the customer ID, and optionally the location information, the server may be configured to establish a call or other messaging transaction between the next available customer service representative 103a and the customer's mobile phone 400. The server 103 will automatically create the call by identifying the available agent and initiating the call to a mobile phone 400 associated with the customer ID inputted at the call-back box 300. In addition, or alternatively, the server 103 may select a customer service agent based on one or more, or both of location information associated with the call back box 300 and/or customer-specific information such as information gleaned from a user profile stored in a database accessible through the server 103. For example, the next available customer service agent with specific language skills, such as Spanish or English, and/or specific product expertise related to the particular store location or customer's order may be identified and connected to the customer's mobile device 400 to further streamline the customer's experience. The transaction will typically include a telephone call, e.g., an IP telephony call and/or analog call connected through one or more IP phone, analog phone, and/or cellular or other wireless telephone networks. However, the customer service representative may be able to communicate with the customer through other messaging protocols, such as instant messaging, text messaging, and/or electronic mail messaging (e-mail) through the customer's mobile phone or other telecommunication device configured for messaging, e.g., a PDA.

Referring to FIG. 5, an exemplary process 500 for establishing a customer service transaction with a customer service agent through a customer's mobile device 400 is shown. A user is provided with access to a call-back box 300, or other customer service terminal 101, having a user interface 305 configured to permit the user to enter a customer ID associated with a mobile device 400 of the customer (user). The user inputs a user-specific customer ID (510) through the user interface 305 that will enable the server 103 to automatically establish a customer service transaction between the customer and the next available customer service agent. Upon receipt of the customer ID at the call-back box 300 (520), the customer ID and optional location information are transmitted through the network interface 201a to the server 103 (530). The call-back box 300, or other customer service terminal 101 is preferably configured to send only the customer ID, and optionally location information, to the server 103 to streamline the user experience and facilitate rapid communication with customer service representatives. However, additional information may be sent and received by the call-back box 300 if desired in specific applications, e.g., a terminal 101 could be configured with additional features permitting payment options through the terminal 101 and/or mobile device 400 of the customer.

If the customer ID is the customer's mobile phone number, the server 103 may automatically establish a customer transaction (540), e.g., as a phone call or through other aforementioned messaging protocols. The server 103 may also include user profiles stored within a database(s), e.g., previously stored user profiles associated with a customer ID recognized from a previous transaction or through a customer account. For example, the customer ID may be an account number that already includes a stored mobile phone number or address that is automatically dialed or messaged upon being sent by the call-back box 300. The server 103 may also provide the customer service agent with any additional information available in the user profile to better assist the customer and customer service agent during the transaction, e.g., user-specific information such as previously placed orders for store pickup, customer preferences for particular items, seating preferences for flights (in an airport setting), or items requested, but on backorder. In addition, or alternatively, the customer service agent 103a may be able to edit, update, and/or access the user profile once the transaction has been established with the customer's mobile device 400, and additional information is obtained during the transaction.

The call-back box 300 or other aforementioned terminal 101 may also be configured to include one or more of the following features. For example, the call-back box may be configured to permit the customer to swipe, e.g., through an optional card reader, an account card or credit card that automatically extracts identifying information that may be associated with a mobile device address or phone number at the server 103. The customer service terminal may be a portable device operably coupled through a wireless network to a customer service server, e.g., and given to a customer to use throughout a retail establishment, such as on a shopping can or for the user to carry. The customer service terminal 101 can be operably coupled through a wired connection to a customer service server on the network or through multiple wired and/or wireless networks, e.g., if the terminal 101 is fixed in a product aisle or beneath an array of flight status monitors in an airport.

Alternatively, or in addition, the call-back box 300 or terminal 101 can be provided with additional hardware, software, and/or firmware, such as microphones and speakers to allow the device to be used to serve as a phone, e.g., if the user does not want to establish the customer service transaction through their own phone. In this case, the user interface 305 may include an additional feature, such as a customer service help button that connects to a customer service agent, but would require the customer to remain in the vicinity of the box 300 or terminal 101 to complete the customer service transaction.

The call-back box can be configured to receive a variety of information back from the server 103. For example, when the call or messaging session between the customer's mobile device 400 and the agent 103a has been established, the server 103 may send a data packet to the box 300 or terminal 101 indicating that the request has been successfully handed-off to the mobile device 400. Alternatively, the server 103 may send a time-out request or request failure message to the box 300 or terminal 101 if an agent is not connected to the customer through the customer's mobile device 400. The various status updates may then be displayed on the user interface 305, e.g., on the display status screen 330.

The customer's mobile device can be a variety of devices, including a cellular phone, a personal digital assistant (PDA), or other RF-based telecommunications device, such as a satellite phone or other radio-frequency based telecommunication device. The server 103 may be configured to establish a customer service transaction, e.g., a phone call or other messaging session, and/or may also permit the customer service transaction to send additional messages or content to the customer's mobile device 400. For example, a customer hoping to obtain available flight information while delayed in an airport terminal, may initiate a customer service transaction with a customer service representative for an airline. During, or at the conclusion of the call, the agent may be able to send flight information on current flights or alternative flights, rental car information, lodging information, and/or travel directions to the customer's mobile device through one or more communication protocols. Specifically, a customer on an active customer service call with an agent, e.g., on a phone call, may also receive web links to content or additional data attached in various messages sent to the mobile device 400 concurrently or after the call, e.g., an instant message with an attachment containing flight information or an e-mail message containing a link to lodging confirmation information and directions accessible through a mobile device's web browser.

While the foregoing implementations have been described in connection with a terminal 101 or call-back box 300 with limited functionality to streamline the user experience, the terminal 101 can be equipped with additional features or functionality. For example, the terminal 101 may be configured as a deskphone 110, or any other telephony device supporting circuit switching, packet switching, and/or other telephony networking may benefit from the implementations. Accordingly, the foregoing implementations are equally applicable to PDAs, VoIP phones, and/or mobile phones. An exemplary telephony device that may incorporate one or more of the foregoing implementations includes any of the Avaya ONE-X deskphones, such as the Avaya ONE-X 9600 and 9650 series.

The terminal 101 may include a processor, a memory, display, and an input/output interface. In addition, the phone, e.g., if used in a network, may include a network interface for sending and receiving data over a network connection, e.g., such as a standard RJ-45 Ethernet connection. The processor may include one or more processors for controlling, interpreting, and/or processing data exchanged between the telephony device and the network. The memory may be one or more memory devices or media capable of storing data or instructions. In addition, or alternatively, the terminal may include an integrated processing device or module, e.g., an analog telephony adapter (ATA) and/or combination of client software residing in memory if desired to include additional features than those described in connection with the implementations shown and described in connection with FIGS. 3-5. The ATA and/or client software may utilize audio codecs to handle data packet conversion, e.g., digital-to-analog conversion of incoming voice data. One or more telecommunications protocols, such as, for example, H.323, may be used to define ways in which video, audio, and/or data is processed and/or transferred through the network which the telephony device is connected.

The preprogramming of the buttons or softkey labels on a terminal 101 to achieve any of the aforementioned features can be achieved in several ways. For example, a system administrator, manufacturer, and/or user may update settings or functions, e.g., control which auxiliary softkey labels are displayed, through periodic updates, e.g., network patches sent to individual client devices to implement global and/or local updates to software resident in the memory of the telephony device. Alternatively, or additionally, the adjustment of softkey label settings may be implemented through a settings menu within the individual client device, e.g., through the menu option button.

The coordinated display of softkey labels and the control of the associated functions and options may be implemented through hardware, firmware, a software module executed by a processor within the telephony device, or in a combination of the two. A software module may reside in RAM memory, flash memory, ROM memory, EPROM memory, EEPROM memory, registers, hard disk, a removable disk, a CD-ROM, or any other form of storage medium known in the art and capable of residing within the terminal and/or associated network server(s). An exemplary storage medium is coupled to the processor such that the processor can read information from, and write information to, the storage medium. In the alternative, the storage medium may be integral to the processor.

Accordingly, one implementation can include a computer readable media embodying a method for establishing a customer service transaction between a user and a customer service representative. Specifically, the method would include receiving a customer ID associated with a mobile device of the user at a user interface of a customer service terminal, transmitting the customer ID to a customer service representative through a network operably coupled to the customer service terminal, and initiating a customer service transaction between the user and the customer service representative, and through the mobile device of the user. The media embodying the aforementioned method can be stored on and/or executed through one or more of the server(s) and/or the terminal 101 or box 300 individually or collectively through the system as a whole.

Although detailed embodiments and implementations have been described above, it should be apparent that various modifications are possible without departing from the spirit and scope of his description.

What is claimed is:

1. A method for establishing a customer service transaction between a user and a customer service representative, the method comprising:
providing the user access to a customer service terminal having a user interface configured to permit the user to enter a customer ID associated with a mobile device of the user;
receiving the customer ID at the customer service terminal;
transmitting the customer ID to a customer service representative through a network operably coupled to the customer service terminal; and
initiating a customer service transaction between the user and the customer service representative and through the mobile device of the user.

2. The method according to claim 1, wherein the customer service terminal is a portable device operably coupled through a wireless network to a customer service server.

3. The method according to claim 1, wherein the customer service terminal is a device operably coupled through a wired connection to a customer service server on the network.

4. The method according to claim 4, wherein the user interface comprises a keypad and a display, the display being configured to display status of a customer service transaction and the customer ID received at the customer service terminal.

5. The method according to claim 1, wherein the user interface consists of a keypad and a display, the display being configured to display status of a customer service transaction and the customer ID received at the customer service terminal.

6. The method according to claim 5, wherein the keypad comprises an alphanumeric keypad and a call request button.

7. The method according to claim 5, wherein the keypad consists of an alphanumeric keypad and a call request button.

8. The method according to claim 1, wherein the customer ID is a mobile telephone number.

9. The method according to claim 1, further comprising:
retrieving a user profile based on the customer ID transmitted to the customer service representative; and
providing user-specific information to the user during the customer service transaction.

10. The method according to claim 1, wherein the customer service transaction comprises at least one of a text message, an instant message, an electronic mail message, or a voice-based telephony call delivered to the user through the mobile device.

11. The method according to claim 1, further comprising transmitting location information associated with the customer service terminal to the customer service representative.

12. The method according to claim 10, further comprising transmitting location information associated with the customer service terminal to the customer service representative.

13. The method according to claim 1, further comprising updating the user with a hand-off status of the customer service transaction on the customer service terminal.

14. The method according to claim 13, wherein updating the user with the hand-off status comprises displaying an indication of a customer service transaction on a display of the customer service terminal.

15. The method according to claim 14, wherein the indication comprises information indicating the customer service transaction being established with the user's mobile device or not being established with the user's mobile device.

16. The method according to claim 1, wherein the mobile device comprises a cellular telephone, a personal digital assistant (PDA), or a RF-based telecommunications device.

17. The method according to claim 1, wherein transmitting the customer ID consists of transmitting only the customer ID and location information associated with the customer service terminal to the customer service representative.

18. The method according to claim 17, further comprising:
retrieving a user profile based on the customer ID transmitted to the customer service representative and the location information; and
providing user-specific information or content to the user during the customer service transaction.

19. A system for establishing a customer service transaction between a user and a customer service representative, the system comprising:
a customer service terminal comprising:
a user interface configured to permit the user to enter a customer ID associated with a mobile device of the user, and
a transmission device configured to transmit the customer ID to a customer service representative through a network operably coupled to the customer service terminal; and
a customer service center comprising a server, operably connected to the customer service terminal through the network, wherein the customer service center is configured to automatically initiate a customer service transaction between the user and the customer service representative based on receipt of the customer ID from the customer service terminal and through a mobile device of the user.

20. The system according to claim 19, wherein the customer service terminal is a portable device operably coupled through a wireless network to the customer service server.

21. The system according to claim 19, wherein the customer service terminal is a device operably coupled through a wired connection to the customer service server on the network.

22. The system according to claim 19, wherein the user interface comprises a keypad and a display, the display being configured to display status of a customer service transaction and the customer ID received at the customer service terminal.

23. The system according to claim 19, wherein the user interface consists of a keypad and a display, the display being configured to display status of a customer service transaction and the customer ID received at the customer service terminal.

24. The system according to claim 22, wherein the keypad comprises an alphanumeric keypad and a call request button.

25. The system according to claim 23, wherein the keypad consists of an alphanumeric keypad and a call request button.

26. The system according to claim 19, wherein the customer ID is a mobile telephone number.

27. The system according to claim 19, wherein the server of the customer service center comprises a database including one or more user profiles associated with one or more customer IDs.

28. The system according to claim 19, wherein the customer service center is configured to transmit a message to the mobile device of the user, the message including at least one of a text message, an instant message, an electronic mail message, or a voice-based telephony call delivered to the user through the mobile device.

29. The system according to claim 19, wherein the server at the customer service center is configured to determine location information associated with the customer service terminal.

30. The system according to claim 22, wherein the user interface is configured to update the user with a hand-off status of the customer service transaction on the display of the customer service terminal.

31. The system according to claim 23, wherein the user interface is configured to update the user with a hand-off status of the customer service transaction on the display of the customer service terminal.

32. The system according to claim 22, wherein the user interface is configured to provide an indication, through the customer service terminal, of the customer service transaction being established with the user's mobile device or not being established with the user's mobile device.

33. The system according to claim 32, wherein the mobile device comprises a cellular telephone, a personal digital assistant (PDA), or a RF-based telecommunications device.

34. The system according to claim 19, wherein the customer service terminal is configured to transmit the customer ID and location information associated with the customer service terminal to the customer service representative.

35. The system according to claim 19, wherein the customer service terminal is configured to transmit only the customer ID and location information associated with the customer service terminal to the customer service representative.

36. A computer-readable medium having computer-executable instructions contained therein for a method for establishing a customer service transaction between a user and a customer service representative, the method comprising:
receiving a customer ID associated with a mobile device of the user at a user interface of a customer service terminal;
transmitting the customer ID to a customer service representative through a network operably coupled to the customer service terminal; and
initiating a customer service transaction between the user and the customer service representative, and through the mobile device of the user.

37. A customer service call-back device, comprising:
a network interface configured to operably connect to a server of a customer service center;
a user interface configured to permit the user to enter a customer ID associated with a mobile device of the user, the user interface including:
a keypad, wherein the keypad includes a call request button configured to initiate a transmission of the customer ID to the server of the customer service center; and
a display, the display being configured to display status of a customer service transaction and the customer ID entered through the keypad of the user interface; and
a transmission device configured to transmit the customer ID to a customer service representative through the network interface and to the customer service center.

38. The customer service call-back device according to claim 19, wherein the user interface consists of only the keypad and the display.

39. The customer service call-back device according to claim 38, wherein the transmission device is configured to transmit only the customer ID and location information associated with a location of the customer service-call back device to the server.
